(19) United States
(12) Patent Application Publication
(10) Pub. No.: US 2019/0193482 A1
(43) Pub. Date: Jun. 27, 2019

(54) PNEUMATIC TIRE

(71) Applicant: TOYO TIRE & RUBBER CO., LTD., Itami-shi (JP)

(72) Inventor: Isao Yonetsu, Itami-shi (JP)

(73) Assignee: TOYO TIRE & RUBBER CO., LTD., Itami-shi (JP)

(21) Appl. No.: 16/207,821

(22) Filed: Dec. 3, 2018

(30) Foreign Application Priority Data
Dec. 22, 2017 (JP) 2017-246902

(51) Int. Cl. B60C 13/00; B60C 13/02

(52) U.S. Cl. CPC B60C 13/001; B60C 13/02

(57) ABSTRACT

A pneumatic tire includes a carcass layer that has a toroidal shape and extends between a pair of bead portions, a sidewall portion, one of the pair of bead portions being provided at an inner end of the sidewall portion in a tire radial direction TR, and a mark formed in an outer surface of the sidewall portion. The mark includes a recessed portion provided in the outer surface of the sidewall portion and recessed inward in a tire width direction, and a mark body defined by the recessed portion. A top surface of the mark body coincides with a reference surface corresponding to the outer surface of the sidewall portion, or is located inside the reference surface in a normal direction of the reference surface.

### CROSS-REFERENCE TO RELATED APPLICATIONS

This application claims priority of Japanese Patent Application No. 2017-246902 filed on Dec. 22, 2017, the content of which is incorporated herein by reference.

### BACKGROUND OF THE INVENTION

### Technical Field

The present invention relates to a pneumatic tire.

### Related Art

A pneumatic tire disclosed in Japanese Patent No. 4449203 includes a recessed mark, and a protruded portion adjacent to the recessed mark, both formed in a surface of a sidewall portion, and specifies a volume ratio of the recessed mark to the protruded portion. According to this pneumatic tire, rubber of the recessed portion is shifted to the protruded portion during tire vulcanization molding to avoid a thickness change of the sidewall portion at a mark position and thereby prevent bending of a carcass layer at the mark position.

However, the pneumatic tire disclosed in Japanese Patent No. 4449203 still has room for improvement concerning local bending of the carcass layer and air resistance of the sidewall portion.

### SUMMARY

An object of the present invention is to provide a pneumatic tire which includes a sidewall portion provided with marks, the tire capable of reducing air resistance in the sidewall portion while reducing local bending of a carcass layer.

An aspect of the present invention provides a pneumatic tire including: a carcass layer that has a toroidal shape and extends between a pair of bead portions; a sidewall portion, one of the pair of bead portions being provided at an inner end of the sidewall portion in a tire radial direction; and a mark formed in an outer surface of the sidewall portion. The mark includes a recessed portion provided in the outer surface of the sidewall portion and recessed inward in a tire width direction, and a mark body defined by the recessed portion. A top surface of the mark body coincides with a reference surface corresponding to the outer surface of the sidewall portion, or is located inside the reference surface in a normal direction of the reference surface.

According to this configuration, the mark is constituted by the recessed portion recessed from the outer surface of the sidewall portion, and the mark body defined by the recessed portion. Accordingly, local bending of the carcass layer can be more reduced compared with the configuration in which the mark body is constituted by a recessed portion. Moreover, the whole of the mark including the mark body is located inside the reference surface of the sidewall portion in the normal direction of the reference surface. Accordingly, air resistance at the sidewall portion can be reduced.

An offset amount in the normal direction between the top surface of the mark body and the reference surface of the side wall portion may be 15% or smaller of a dimension of the sidewall portion in the normal direction.

According to this configuration, the offset amount in the normal direction of the reference surface between the top surface of the mark body and the reference surface of the sidewall portion is set within the appropriate range. Accordingly, effective reduction of local bending of the carcass layer located inside the mark body in the normal direction is achievable. When the offset amount in the normal direction of the reference surface between the top surface of the mark body and the reference surface of the sidewall portion is larger than 15% of the dimension of the sidewall portion in the normal direction of the reference surface, local bending of the carcass layer located inside the mark body in the normal direction increases.

The recessed portion may include a first surface continuous with the top surface of the mark body, and a second surface continuous with the outer surface of the sidewall portion.

The recessed portion may include a third surface that connects the first surface and the second surface.

The first surface may be linear in a cross section orthogonal to a direction in which the recessed portion extends. An angle formed by the first surface and the normal direction in the cross section orthogonal to the direction in which the recessed portion may extend lies in a range from 5° inclusive to 30° inclusive.

According to this configuration, the angle formed by the first surface of the recessed portion and the normal direction of the reference surface in the cross section orthogonal to the direction in which the recessed portion extends is specified within the appropriate range. Accordingly, local bending of the carcass layer can be reduced while securing visibility of the mark. When the angle formed by the first surface of the recessed portion and the normal direction of the reference surface is larger than the above range, the boundary between the mark body and the recessed portion becomes unclear. In this case, sufficient visibility of the mark cannot be secured. When the angle formed by the first surface of the recessed portion and the normal direction of the reference surface is smaller than the above range, the dimension of the recessed portion in the direction orthogonal to the normal direction becomes excessively larger. In this case, an area of the recessed portion affecting the shape of the carcass layer increases.

A maximum dimension of the recessed portion in a direction orthogonal to the normal direction in a cross section orthogonal to a direction in which the recessed portion extends may lie in a range from 2.5 times inclusive to 5 times inclusive a maximum dimension of the recessed portion in the normal direction.

According to this configuration, the maximum dimension of the recessed portion in the direction orthogonal to the normal direction of the reference surface is specified in the appropriate range described above (2.5 times inclusive to 5 times inclusive maximum dimension of recessed portion in normal direction) in the cross section orthogonal to the direction in which the recessed portion extends. In this case, local bending of the carcass layer can be reduced while securing visibility of the mark. When the maximum dimension of the recessed portion in the direction orthogonal to the normal direction of the reference surface is larger than the above range, the dimension of the recessed portion in the direction orthogonal to the normal direction of the reference surface becomes excessively larger. In this case, an area of the recessed portion affecting the shape of the carcass layer increases. When the maximum dimension of the recessed portion in the direction orthogonal to the normal direction of the reference surface is smaller than the above range, a visible area of the recessed portion decreases. In this case, sufficient visibility cannot be secured.

According to the present invention, the mark is constituted by the recessed portion recessed from the outer surface of the sidewall portion, and the mark body defined by the recessed portion. Accordingly, local bending of the carcass layer can be more reduced compared with the configuration in which the mark body is constituted by a recessed portion. Moreover, the whole of the mark including the mark body is located inside the reference surface of the sidewall portion in the normal direction of the reference surface. Accordingly, air resistance at the sidewall portion can be reduced.

### BRIEF DESCRIPTION OF THE DRAWINGS

The foregoing and the other features of the present invention will become apparent from the following description and drawings of an illustrative embodiment of the invention in which:

FIG. 1 is a cross-sectional view of a pneumatic tire in a meridian direction according to a first embodiment of the present invention;

FIG. 2 is a perspective view of a mark according to the first embodiment as viewed from an outside in a tire width direction;

FIG. 3 is a cross-sectional view of a main part taken along a line III-Ill of FIG. 2;

FIG. 4 is a cross-sectional view of a sidewall portion according to a second embodiment of the present invention, as a view corresponding to FIG. 3;

FIG. 5 is a cross-sectional view of a sidewall portion according to a third embodiment of the present invention, as a view corresponding to FIG. 3; and

FIG. 6 is a cross-sectional view of a sidewall portion according to a fourth embodiment of the present invention, as a view corresponding to FIG. 3.

### DETAILED DESCRIPTION OF EMBODIMENTS

Embodiments of the present invention will be hereinafter described with reference to the accompanying drawings. In the accompanying drawings referred to below, a tire radial direction and a tire width direction are given reference signs TR and TW, respectively.

### First Embodiment

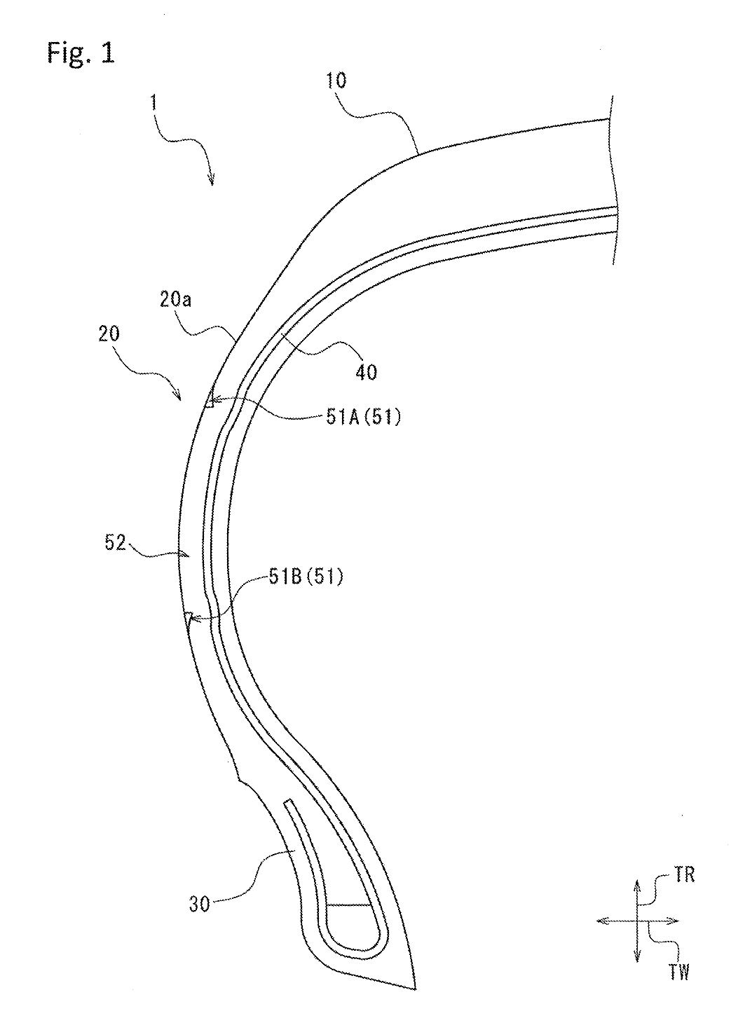

Referring to FIG. 1, a pneumatic tire 1 includes a tread portion 10, a sidewall portion 20, and a pair of bead portions 30. The sidewall portions 20 extend from both end portions of the tread portions 10 in the tire width direction TW while curving toward the inside in the tire radial direction TR. Each of the bead portions 30 is provided at an inner end of the corresponding sidewall portion 20 in the tire radial direction TR. A carcass layer 40 having a toroidal shape is extended between the pair of bead portions 30 inside the pneumatic tire 1. The accompanying drawing does not show internal structures except for the carcass layer 40.

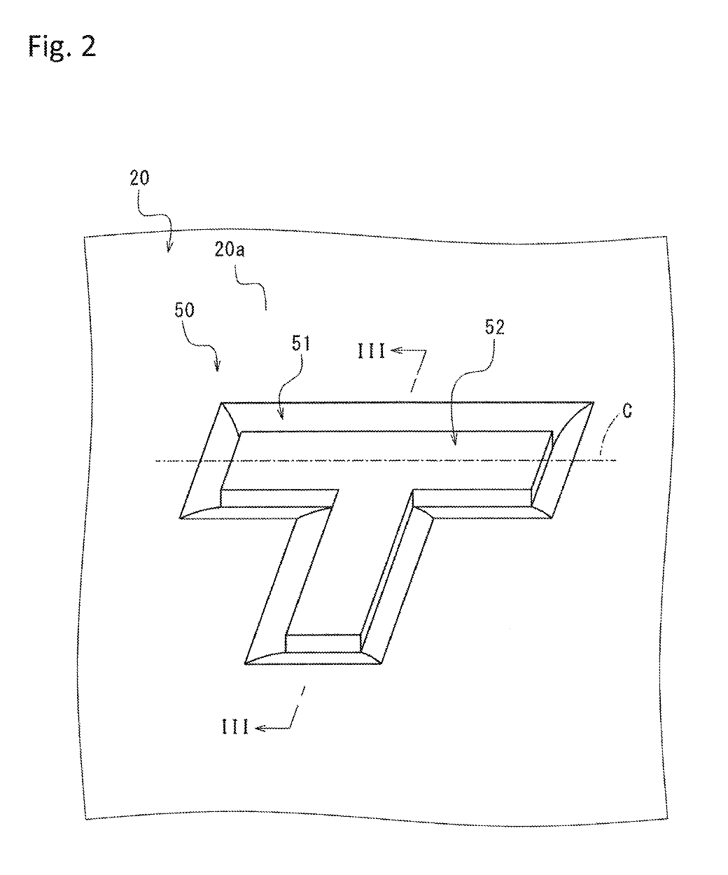

The sidewall portion 20 of the present embodiment has an outer surface 20a having an arcuate shape in a tire meridian cross section. Referring to FIG. 2 in conjunction with the foregoing figure, a mark 50 is formed in the outer surface 20a of the sidewall portion 20. According to the present embodiment, the mark 50 has a shape similar to an alphabetic capital letter “T” as shown in FIG. 2. The mark 50 includes a recessed portion 51 recessed inward in the tire width direction TW from the outer surface 20a of the sidewall portion 20, and a mark body 52 defined by the recessed portion 51.

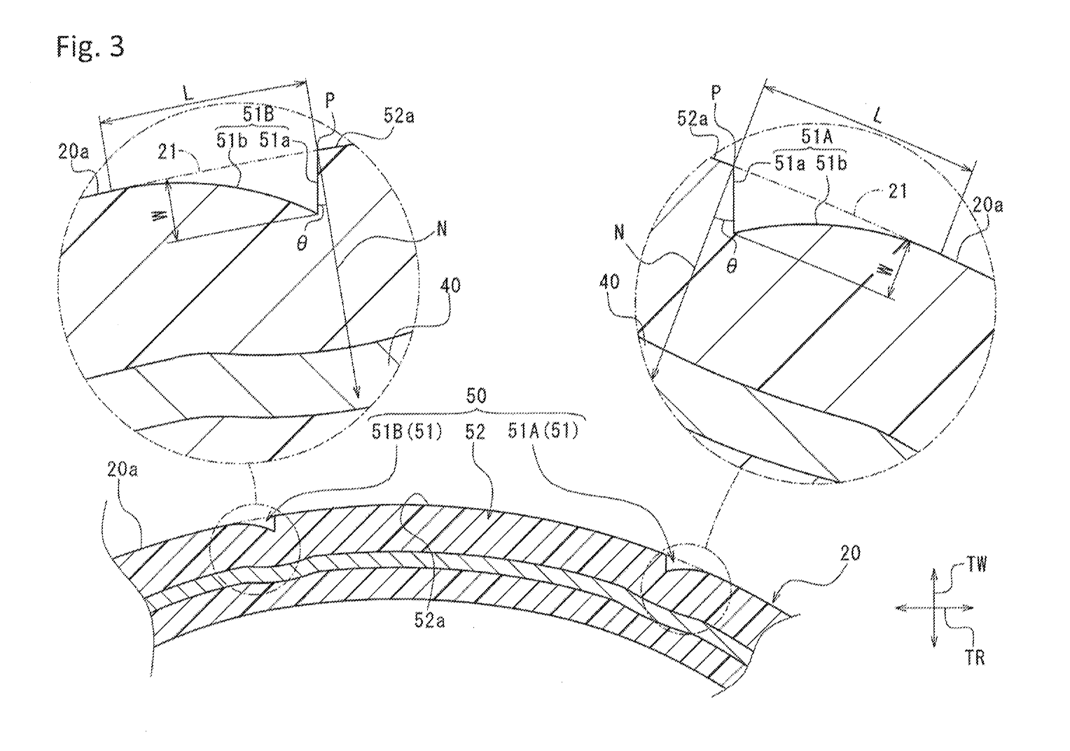

The recessed portion 51 of the present embodiment is so formed as to line an edge of the letter “T”. The mark body 52 is therefore so defined as to represent the letter “T”. For example, in the cross section shown in FIG. 3, the recessed portion 51 includes recesses 51A and 51B formed at two different positions of the sidewall portion 20 in the tire radial direction TR. This cross section is a cross section orthogonal to directions in which the recesses 51A and 51B extend, and is a tire meridian cross section according to the present embodiment. Each of the recesses 51A and 51B of the present embodiment includes a first surface 51a continuous with a top surface 52a of the mark body 52, and a second surface 51b continuous with the outer surface 20a of the sidewall portion 20. The first surface 51a of the present embodiment is formed continuously with the second surface 51b. Each of the first surfaces 51a of the recesses 51A and 51B of the present embodiment has a linear shape extending in the tire width direction TW in the tire meridian cross section. An angle θ formed by each of the first surfaces 51a of the recessed portions 51A and 51B and a normal direction N of a reference surface 21 passing through a reference point P in the tire meridian cross section is set within a range from 5° inclusive to 30° inclusive. The reference point P of the present embodiment is a boundary point between the mark body 52 and each of the recesses 51A and 51B. The second surface 51b of each of the recesses 51A and 51B of the present embodiment is arcuate in the tire meridian cross section.

A maximum dimension L of each of the recesses 51A and 51B in a direction orthogonal to the normal direction N is set within a range from 2.5 times inclusive to 5 times inclusive a maximum dimension W of each of the recesses 51A and 51B in the normal direction N.

The top surface 52a of the mark body 52 of the present embodiment is a curved surface that coincides with the reference surface 21 corresponding to the outer surface 20a of the sidewall portion 20.

The reference surface 21 is a virtual curved surface which represents an outer surface of the sidewall portion 20 in a configuration not including the mark 50, and smoothly connects the outer surface 20a of the sidewall portion 20.

According to the foregoing configuration, the mark 50 is constituted by the recessed portion 51 recessed from the outer surface 20a of the sidewall portion 20, and the mark body 52 defined by the recessed portion 51. Accordingly, local bending of the carcass layer 40 can be more reduced compared with the configuration in which the mark body 52 is constituted by a recessed portion. Moreover, the whole of the mark 50 including the mark body 52 is located inside the reference surface 21 of the sidewall portion 20 in the normal direction N of the reference surface 21. Accordingly, air resistance at the sidewall portion 20 can be reduced.

The angle θ formed by each of the first surfaces 51a of the recesses 51A and 51B and the normal direction N of the reference surface 21 in the cross section orthogonal to the directions in which the recesses 51A and 51B extend is specified within the appropriate range described above (from 5° inclusive to 30° inclusive). Accordingly, local bending of the carcass layer 40 can be reduced while securing visibility of the mark 50. When the angle θ formed by each of the first surfaces 51a of the recessed portions 51A and 51B and the normal direction N of the reference surface 21 is larger than the above range, the boundary between the mark body 52 and the recesses 51A and 51B becomes unclear. In this case, sufficient visibility of the mark 50 cannot be secured. When the angle θ formed by each of the first surfaces 51a of the recesses 51A and 51B and the normal direction N of the reference surface 21 is smaller than the above range, the dimension of each of the recess 51A and the recess 51B in the direction orthogonal to the normal direction N becomes excessively larger. In this case, areas of the recesses 51A and 51B affecting the shape of the carcass layer 40 increase.

Moreover, the maximum dimension L of each of the recesses 51A and 51B in the direction orthogonal to the normal direction N is specified in the appropriate range described above (2.5 times inclusive to 5 times inclusive maximum dimension W of recesses 51A and 51B in normal direction N). In this case, local bending of the carcass layer 40 can be reduced while securing visibility of the mark 50. When the maximum dimension L of each of the recesses 51A and 51B in the direction orthogonal to the normal direction N is larger than the above range, the dimension of each of the recess 51A and the recess 51B in the direction orthogonal to the normal direction N becomes excessively larger. In this case, areas of the recesses 51A and 51B affecting the shape of the carcass layer 40 increase. When the maximum dimension L of each of the recesses 51A and 51B in the direction orthogonal to the normal direction N is smaller than the above range, visible areas of the recesses 51A and 51B decrease. In this case, sufficient visibility cannot be secured.

While the recesses 51A and 51B appearing in the tire meridian cross section have been described in the present embodiment, but the embodiment is not limited thereto, and other parts in the recessed portion 51 may have a configuration similar to the recesses 51A and 51B in a cross section orthogonal to the direction in which the recessed portion 51 extends. For example, the recessed portion 51 has a configuration similar to the recesses 51A and 51B in a cross section along a line C in FIG. 2.

In second to fourth embodiments described below, elements identical or similar to the corresponding elements of the first embodiment are given identical reference numbers, and detailed description of these elements are not repeated. In addition, advantageous effects similar to those of the first embodiment are produced in the following respective embodiments unless particularly noted otherwise.

### Second Embodiment

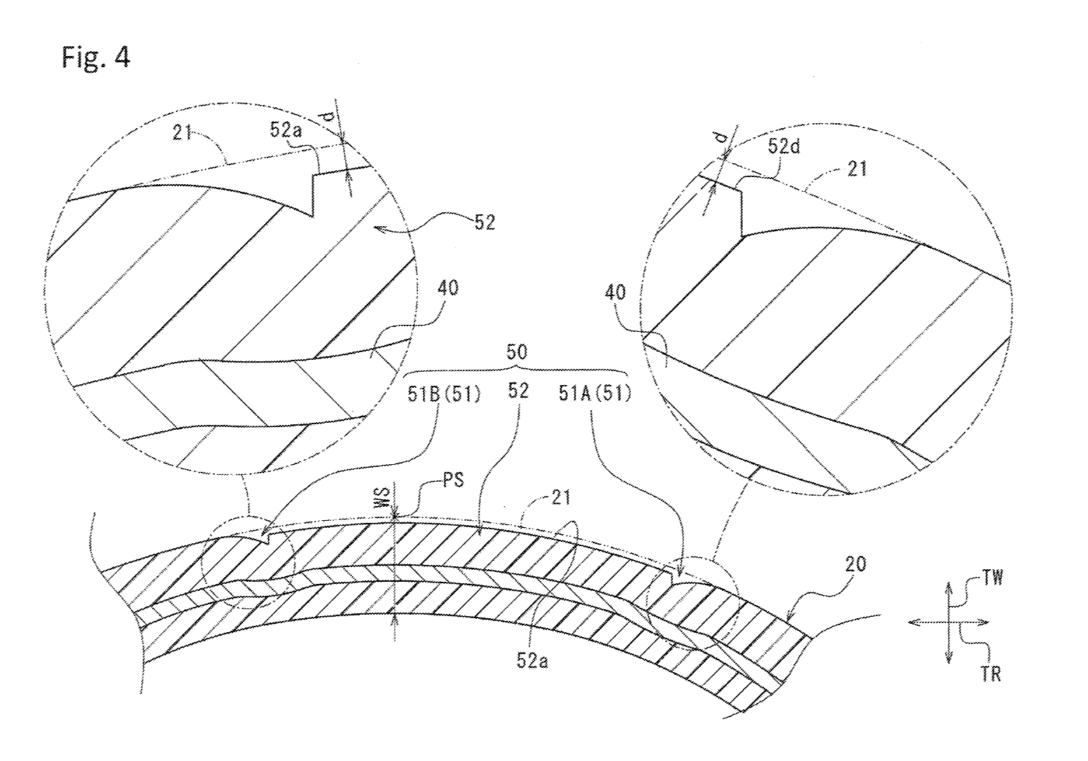

Referring to FIG. 4, the top surface 52a of the mark body 52 of the present embodiment is disposed inside the reference surface 21 of the sidewall portion 20 in the normal direction of the reference surface 21. The top surface 52a of the mark body 52 is substantially parallel to the reference surface 21 of the sidewall portion 20 in the tire meridian cross section. An offset amount d in the normal direction of the reference surface 21 between the top surface 52a of the mark body 52 and the reference surface 21 of the sidewall portion 20 is set in a range of 15% or smaller of a dimension WS of the sidewall portion 20 in the normal direction. The dimension WS of the sidewall portion 20 in the normal direction is a dimension of the sidewall portion 20 in the normal direction at an outermost point PS of the sidewall portion 20 in the tire width direction TW.

According to this configuration, the offset amount d in the normal direction between the top surface 52a of the mark body 52 and the reference surface 21 of the sidewall portion 20 is specified within the appropriate range (15% or smaller of dimension WS of sidewall portion 20 in normal direction). Accordingly, effective reduction of local bending of the carcass layer 40 located inside the mark body 52 in the normal direction is achievable. When the offset amount d in the normal direction between the top surface 52a of the mark body 52 and the reference surface 21 of the sidewall portion 20 is larger than 15% of the dimension WS of the sidewall portion 20 in the normal direction, local bending of the carcass layer 40 located inside the mark body 52 in the normal direction increases.

### Third Embodiment

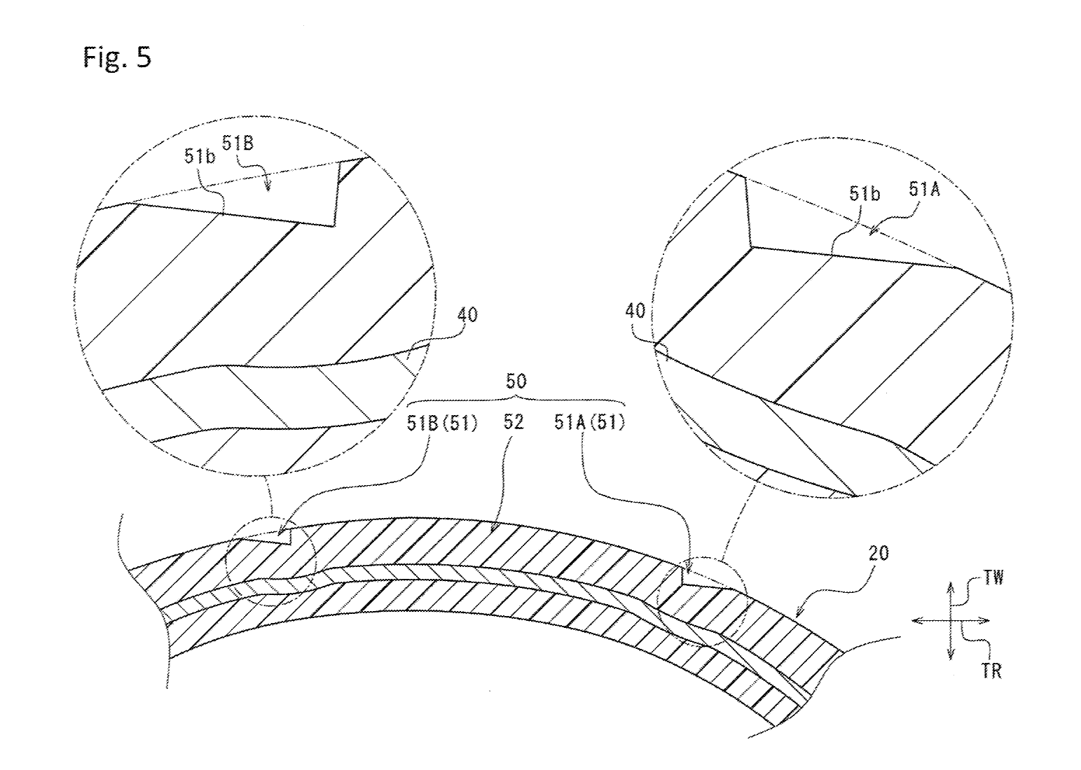

Referring to FIG. 5, the second surface 51b of each of the recesses 51A and 51B of the present embodiment is linear in the tire meridian cross section.

### Fourth Embodiment

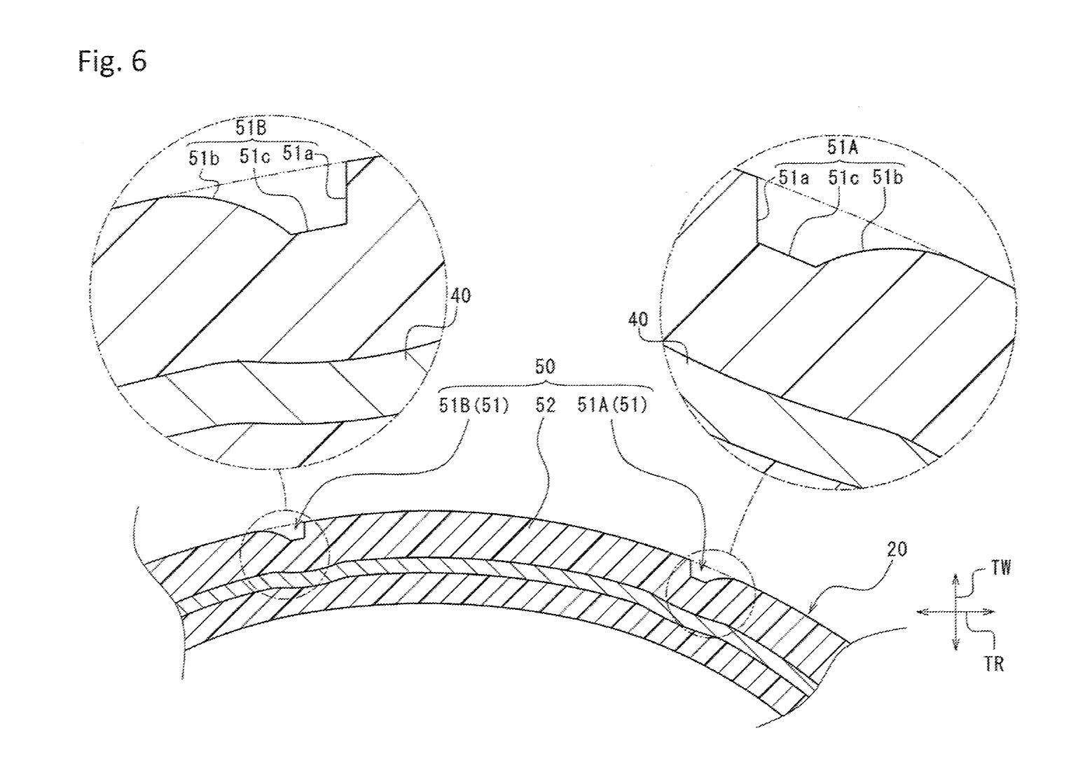

Referring to FIG. 6, each of the recesses 51A and 51B of the present embodiment includes a third surface 51c that connects the first surface 51a and the second surface 51b. The third surface 51c is linear in the tire meridian cross section.

Although the specific embodiments of the present invention have been described, the present invention is not limited to the above embodiments. Various modifications may be made without departing from the scope of the present invention.

For example, the sidewall portion 20 may include serrations.

The mark 50 may be constituted by any mark selected from a letter, a figure, and a symbol, or a combination of these. For example, the character represented by the mark 50 is not limited to the alphabetic capital letter “T” as shown in the above embodiment.

What is claimed is:

1. A pneumatic tire comprising:
a carcass layer that has a toroidal shape and extends between a pair of bead portions;
a sidewall portion, one of the pair of bead portions being provided at an inner end of the sidewall portion in a tire radial direction; and
a mark formed in an outer surface of the sidewall portion, wherein
the mark includes:
a recessed portion provided in the outer surface of the sidewall portion and recessed inward in a tire width direction; and
a mark body defined by the recessed portion, and
a top surface of the mark body coincides with a reference surface corresponding to the outer surface of the sidewall portion, or is located inside the reference surface in a normal direction of the reference surface.

2. The pneumatic tire according to claim 1, wherein an offset amount in the normal direction between the top surface of the mark body and the reference surface of the side wall portion is 15% or smaller of a dimension of the sidewall portion in the normal direction.

3. The pneumatic tire according to claim 1, wherein the recessed portion includes:
a first surface continuous with the top surface of the mark body; and
a second surface continuous with the outer surface of the sidewall portion.

4. The pneumatic tire according to claim 3, wherein the recessed portion includes a third surface that connects the first surface and the second surface.

5. The pneumatic tire according to claim 3, wherein
the first surface is linear in a cross section orthogonal to a direction in which the recessed portion extends, and
an angle formed by the first surface and the normal direction in the cross section orthogonal to the direction in which the recessed portion extends lies in a range from 5° inclusive to 30° inclusive.

6. The pneumatic tire according to claim 4, wherein
the first surface is linear in a cross section orthogonal to a direction in which the recessed portion extends, and
an angle formed by the first surface and the normal direction in the cross section orthogonal to the direction in which the recessed portion extends lies in a range from 5° inclusive to 30° inclusive.

7. The pneumatic tire according to claim 1, wherein a maximum dimension of the recessed portion in a direction orthogonal to the normal direction in a cross section orthogonal to a direction in which the recessed portion extends lies in a range from 2.5 times inclusive to 5 times inclusive a maximum dimension of the recessed portion in the normal direction.

8. The pneumatic tire according to claim 2, wherein a maximum dimension of the recessed portion in a direction orthogonal to the normal direction in a cross section orthogonal to a direction in which the recessed portion extends lies in a range from 2.5 times inclusive to 5 times inclusive a maximum dimension of the recessed portion in the normal direction.

9. The pneumatic tire according to claim 3, wherein a maximum dimension of the recessed portion in a direction orthogonal to the normal direction in a cross section orthogonal to a direction in which the recessed portion extends lies in a range from 2.5 times inclusive to 5 times inclusive a maximum dimension of the recessed portion in the normal direction.

10. The pneumatic tire according to claim 4, wherein a maximum dimension of the recessed portion in a direction orthogonal to the normal direction in a cross section orthogonal to a direction in which the recessed portion extends lies in a range from 2.5 times inclusive to 5 times inclusive a maximum dimension of the recessed portion in the normal direction.

11. The pneumatic tire according to claim 5, wherein a maximum dimension of the recessed portion in a direction orthogonal to the normal direction in a cross section orthogonal to a direction in which the recessed portion extends lies in a range from 2.5 times inclusive to 5 times inclusive a maximum dimension of the recessed portion in the normal direction.

12. The pneumatic tire according to claim 6, wherein a maximum dimension of the recessed portion in a direction orthogonal to the normal direction in a cross section orthogonal to a direction in which the recessed portion extends lies in a range from 2.5 times inclusive to 5 times inclusive a maximum dimension of the recessed portion in the normal direction.
